(19) United States
(12) Patent Application Publication
(10) Pub. No.: US 2015/0048912 A1
(43) Pub. Date: Feb. 19, 2015

(54) ETERNAL ENGINE

(71) Applicant: Anh Tai Do, Ho Chi Minh City (VN)

(72) Inventor: Anh Tai Do, Ho Chi Minh City (VN)

(21) Appl. No.: 14/022,250

(22) Filed: Sep. 10, 2013

(30) Foreign Application Priority Data
Aug. 15, 2013 (VN) 1-2013-02542

(51) Int. Cl. H01F 7/02

(52) U.S. Cl. CPC H01F 7/0231; Y10S 74/09; H02K 53/00
USPC 335/219; 74/DIG. 9

(57) ABSTRACT

Use energy resource from gravity (magnetic force) of permanent magnet and apply the principle of “Magnetic field, magnetic force of permanent magnet was holding (stopped), can not get out of the closed environment of a metal with very high magnetic permeability”, along with applying laws of physics and the physical-chemical properties different types of material in nature. Eternal Engine invented in the form of a cylinder system, operated by the innovative method that closed-open automatically the fixed magnetic force of permanent magnets.

### TECHNICAL AREAS MENTIONED

Patent research and mention the motor/engine can self-propel (self-operate) long, continuously to generate energy the motor/engine is damaged without being impacted by any external force or supply any fuel during the operation.

### TECHNICAL CONDITION OF THE FIELD OF USE OF THE INVENTION

Through research, I (the author) have inferred that all the research and inventions related to previous self-propelled motor/engine according to the field of technical area mentioned above failed because:
Nothing can violate the laws of thermodynamics, which are mostly “law of conservation of energy and metabolism.”
Many studies tend to come close to very long and continuous motion, does not require the useful life, but also ignore friction factors and other environmental agents. This is not possible and also failed.
Some studies take advantage of the magnetic force of permanent magnets, in some cases combined with the gravitational force of the earth. But the impact force of the permanent magnet is invariant to put magnet in a fixed position, resulting that there will be no continuous motion. Further, in other cases, the movement will be halted when the magnetic force of the magnet and gravitational force of the moving objects meet at equilibrium.

### TECHNICAL NATURE OF THE INVENTION

### 1. The Purpose of the Invention

The purpose of the invention is to create a/an motor/engine capable of self-activity, self-operated continuous, long-term and the useful life (until the engine is damaged) without impact of any external force or supply of any fuel during the operation.

The concept of the engine is damaged shall be construed:
A division, or/and many, or/and all the component parts of the motor/engine during operation lasting no longer be itself to the extent that the motor/engine could not continue to be active again.
A link, or/and many, or/and all the links of the engine during operation lasting no longer keep/get fit together according to the structure of the motor/engine to the motor/engine that could not continue to be active again.

### 2. How to Achieve the Following Purposes:

In order to achieve the purpose, learning from the earlier failures, the author has put the research in a new direction, trying to avoid the previous and past mistakes. Still taking advantage of the power of permanent magnets, but the problem is how to control this attraction in our discretion. At the same time a combined application of the laws of physics, the physical and chemical properties of different types of material in nature. The goal is to the motor/engine can operate based on the use of magnetic force of permanent magnet, and then this magnetic force is further facilitated useful in a closed system, ensuring do not violate the laws of thermodynamics.

In a study seeking how to lock magnetic force of permanent magnets in a metal box to prevent influence outside. The authorput a permanent magnet (type Nd2Fe14B) inside a pure iron box (iron with impurity<0.1%) with 2 cm (centimeters) thick, tight, and very high magnetic permeability. The result was that the permanent magnet inside could not attract (pull) solf ferromagnetic materials (Ex: Iron) outside anymore (unless soft ferromagnetic materials are located close to the metal box). The reason the entire magnetic field of permanent magnet was located and running in metal section of the box with high permeability said above, no longer outside. In other words, the magnetic force is now no longer on the outside to work on soft ferromagnetic materials in exterior. There is an application of this principle to control the way to open and to close (off) permanent magnet attraction, along with the application of rules available scientific in nature, using the physical and chemical properties of different materials. The author invented the Self-Propelled Motor/Engine (hereinafter sometimes referred to as Engine or patent) in detailed description to the specific model will be presented below.

### BRIEF DESCRIPTION OF DRAWINGS

1. FIG. 1a: The whole patent looked from the outside

FIG. 1b: The whole longitudinal section of the patent

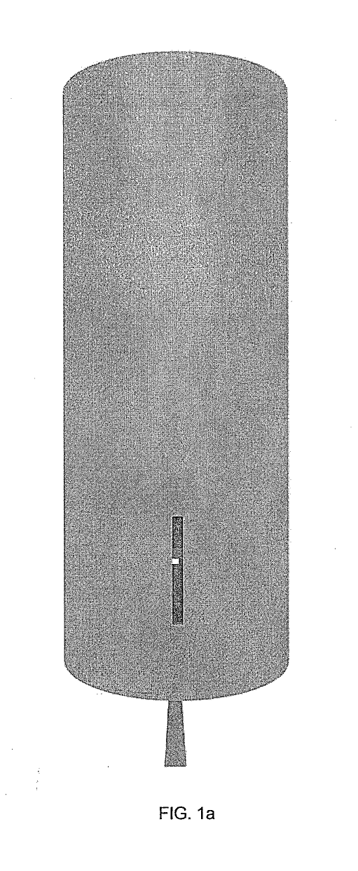

2. FIG. 2a: Cylinder cage looked from the outside

FIG. 2b: Longitudinal section of Cylinder cage

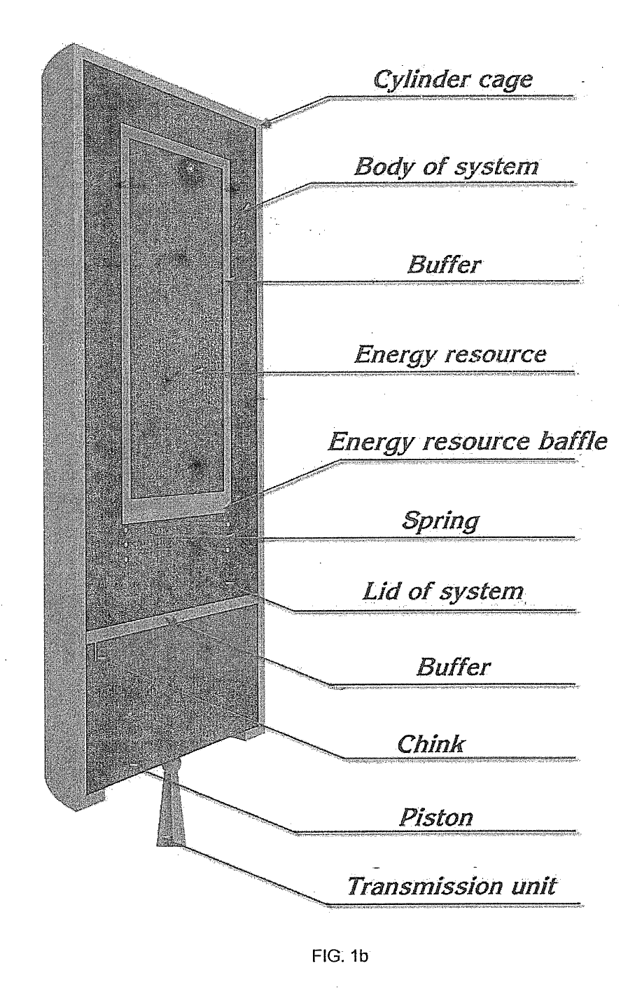

3. FIG. 3a: Energy resource looked from the outside

FIG. 3b: Longitudinal section of Energy resource

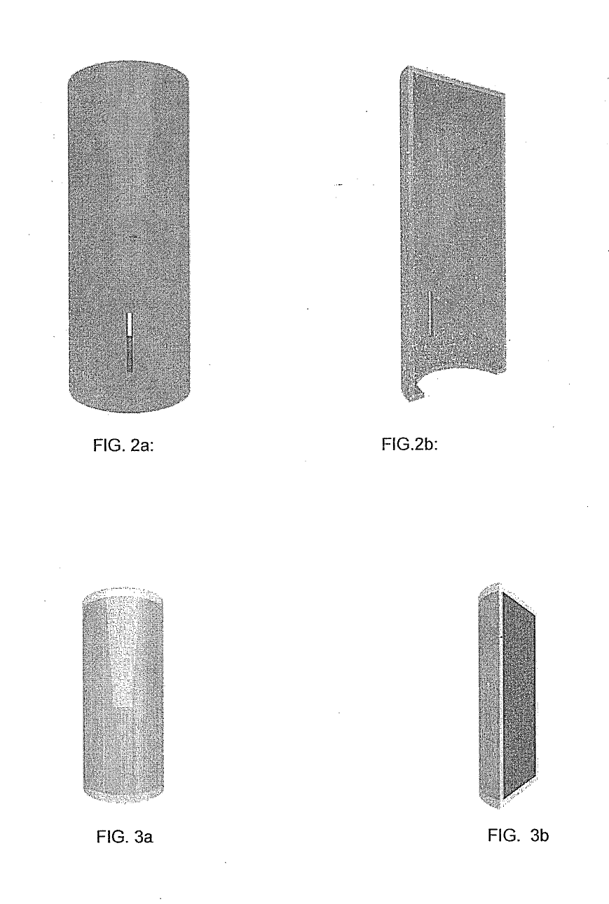

4. FIG. 4a: Longitudinal section of Body of system

FIG. 4b: Lid of system

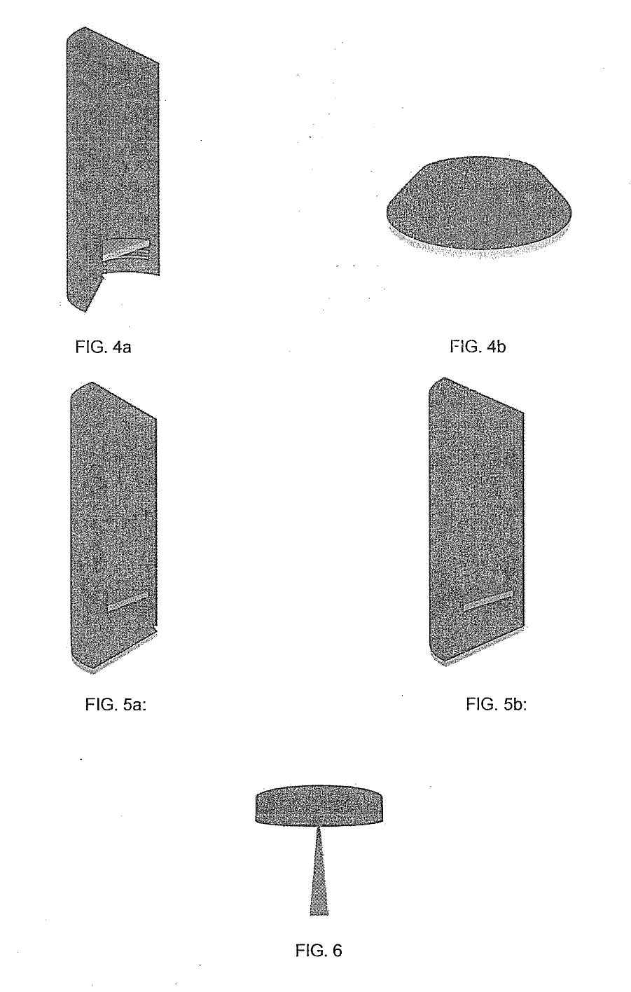

5. FIG. 5a: Closed-open system in “open state”

FIG. 5b: Closed-open system in “closed state”

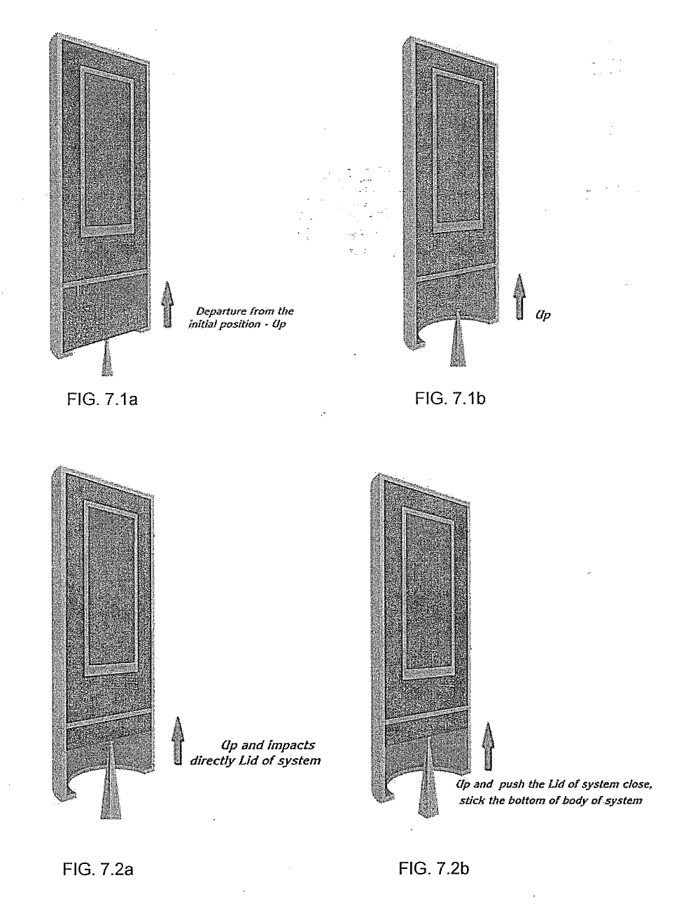

6. FIG. 6: Piston

7. Drawings to describe method of operation of the invention
Piston moves up: FIG. 7.1a, FIG. 7.1b
Piston collides, interrupts (stop) Energy resource and then moves down: FIG. 7.2a, FIG. 7.2b, FIG. 7.2c.

FIG. 7.3 Piston and the whole Engine (patent) return to the initial position.

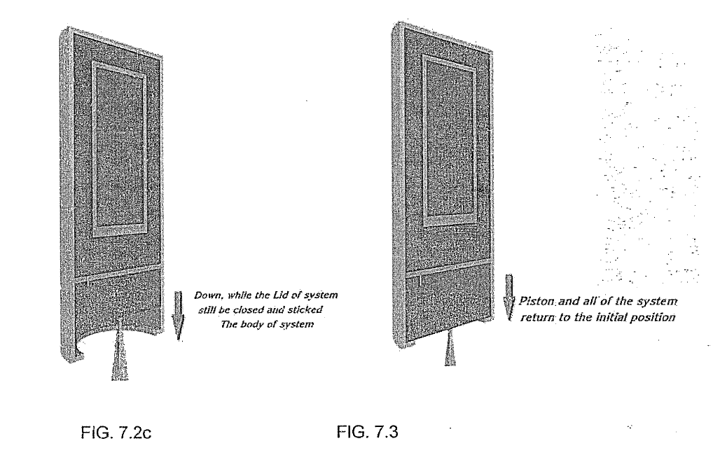

### DETAILED DESCRIPTION OF THE INVENTION

### A. Describe the Structure (the Structure of the Invention in Static State)

As the figure illustrates, the Engine is almost the same ousite shape as a internal combustion engine currently popular. In the popular state, the Engine is placed on the earth's surface, and a vertical plane perpendicular to the Earth. Includes a circular cylindrical cylinder system (hereinafter referred to as cylinder system), connected with transmission unit under in fixed and vertical axis.

Describe Specific Design as Follows:

### 1. Cylinder System

Includes: Outside of the cylinder system is cylinder cage, inside from top to bottom respectively are energy resource unit is fixed, followed by piston (which connects directly with transmission unit) will move in the work process of the Engine. Specific parts in turn is presented below.

### 1.1. Cylinder Cage:

Is a circular cylindrical, hollow, opening at the bottom with a flange inside 1 cm wide, smooth inside to minimize friction, 30 cm long, 0.5 cm thick, 11 cm diameter inside. The cage shall be made of sturdy material, durable and shall not be affected by magnetic field, magnetic force of permanent magnets. Should be diamagnetic metal or permeability metal by 1, and thermally conductive. In this model description, the author has used copper metal (Cu). This material shall be helpful to keep the engine cool normally.

Cylinder cage got two chinks (each chink has an area (0.5 cm×5 cm)) symmetry, parallel along the cylinder cage from the top of cylinder cage 21.5 cm. Purpose is to the cylinder cage not be compressed by air in the work process of the Engine.

### 1.2. Energy Resource Unit:

Consists energy resource and closed-open energy resource system (referred to as closed-open system).

### 1.2.1. Energy Resource:

Create energy for the Engine. This is the innermost core of Energy resource unit. Made of permanent magnet, capable type of producing magnetic force ultra strong, stable, durable, withstand temperatures up to about 200 degrees C. In this model description, the energy resource is the good type of permanent magnet Nd2Fe14B; circular cylindrical with 6 cm diameter, 15 cm long; adhesive coated exterior antioxidants; the north pole is on top, the south pole is at the bottom.

Energy resource is tightly shielded, closed by non-metal materials with soft and not influenced by the magnetic force, thickness 0.5 cm. In this model description, the author has used cotton and wood paper. This acts as a buffer to avoid effects of oxidation, shock, collision, temperature rise for energy resource. It also helps the energy resource to be stable, durable, without shrinkage, and ensuring no change in the magnetic force during the operation of Engine.

Note: As all previous studies and have been scientifically recognized, the magnetic field is a form of matter, magnetic force of permanent magnets only loss (decrease) in the cases of permanent magnets are oxidized, and/or collided, and/or the temperature is increased beyond the threshold, and for demagnetized by the methods of demagnetization.

### 1.2.2. Closed-Open System:

Next, outside of energy resource is closed-open system. This is the core, which create operating principle of the Engine.

Except auxiliaries such as energy resource baffle, spring, buffer of lid of system will be presented in details later. Physical entire structure of closed-open system is hard metal, relatively thick, durable, high antioxidant capacity, very large magnetic force effects and not magnetized. In other words, this is a magnetic metal, with very high magnetic permeability, coercive force is very small. A good idea is one of the metals: Purified iron (impurity<0.01%), Supermalloy (alloy Ni75Fe25), nano-crystalline soft magnetic materials Finemet (validated components of Fe73,5Si13,5B9Nb3Cu1). In this description, the closed-open system is made by one of three materials mentioned above.

The closed-open system includes the following parts:

a. Body of Closed-Open System

(or referred to as body of system) is a circular cylindrical, hollow, opening at the bottom, 2 cm thick, 22 cm long, 11 cm outside diameter, 7 cm inside diameter. Inside surface of the bottom is cut out 45 degrees with smooth circle. In addition, body of system has got two auxiliary parts which are Energy resource baffle and spring. Description body of system from the top to the bottom as follows:
Inside, on the top is the body of system which contains the energy resource.
Next is energy resource baffle, 0.5 cm thick, circle with 7 cm diameter. Energy resource baffle is fitted, closed, right the bottom of the energy resource. It is also made of material similar to cylinder cage (diamagnetic metal, unaffected by the magnetic force, it is copper metal (Cu)). Energy resource baffle takes effects grasping, enables to keep fixed the energy resource; simultaneously, which is also attached to spring will be presented below.
Next is spring: The top of spring are attached to the Energy resource baffle as mentioned above, the bottom of spring is attached to lid of closed-open system (or referred to as lid of system) will be presented following. The Spring got outside diameter 6.8 cm (to reduce rub inside body of system in the work process of the Engine), made of metal with durable, elastic, diamagnetic, and unaffected by the magnetic force (in this model description, it is copper (Cu)). The spring shall ensure sufficient strength to win magnetic attraction of energy resource to push the lid of system from location close (with the bottom of body of system) to location open and then maintains a fixed distance 0.5 cm.

### B. Lid of Closed-Open System (Lid of System):

Is a circular cylindrical piece of metal with 2 cm thick, 10.94 cm diameter (to avoid and reduce rub inside cylinder cage in the work process of the Engine). The top surface is adjacent and opposite to the bottom of body of system. The side surface is cut out 45 degrees from bottom to top with smooth circle, purpose is to the lid of system can be closely pressed, fitted in the bottom of body of system. The underside (bottom) is flat, glued to a thick buffer 0.5 cm by materials that are not affected by magnetic force (similar to the wrapper of energy resource, it is wood paper or cotton). This is done to act as a environmental barrier between closed-open system and piston to prevent in case the lid of system and the piston collide during Engine operation.
If the lid of system and the bottom of body of system is separated (open), it is said that the energy resource unit is in “open state”.
Conversely, if the lid of system and the bottom of body of system is closed, it is said that the energy resource unit is in “closed state”.

### 1.3. Piston:

Similar to the lid of system, Piston is a circular cylindrical piece of metal with 2 cm thick, 10.94 cm diameter, made of metal similar to the lid of system. The top surface and the bottom surface are flat, the side surface is smooth. The bottom surface is connected directly to transmission unit. In this model description, in “open state”, the longest distance between the lid of system (including the buffer) and the top surface of piston is 4 cm. Depending on the capacity of energy resource and the need to produce, piston thickness and the longest distance above will be adjusted accordingly.

### 2. Transmission Unit:

Similar to cylinder cage, entire transmission unit should be made of copper metal (Cu). Applicant does not elaborate on the description of structure and operation of the transmission unit, because it has been a popular application. Putting transmission unit into this model description to aim illustrate the invention can generate useful energy outside.

### B. Mode of Operation of the Invention (Based on the Common State of the Engine):

1. At the “open state” of energy resource unit, under effect of magnetic force of energy resource, piston from the bottom position of the cylinder cage (which connects transmission unit), is pulled up towards the top of Engine. In principle, magnetic force will be as strong as soft ferromagnetic materials get closer. So as more head towards energy resource unit, as the speed of piston increasing.
2. Moving up to energy resource unit, piston collides directly the lid of system, and be transformed into kinetic energy to create a force exerting the lid of system, push the lid of system upward untill impact, close, and then stick the bottom of body of system because of magnetic force of energy resource and presence of inertial force. At this moment, energy resource unit reverts to “closed state”. Up to research cited in IV.2, at this moment, there is no magnetic force exerting on the piston any more. Due to gravitational force and opposite interaction force of the last collision, plus inertia of flywheel of transmission unit, piston moves down immediately returning to the initial position.
3. Simultaneously with moment piston back into the departure position, kinetic energy and inertial force acting on the lid of system due to the collision said above disappears, under the effect of the elastic force of the spring, the lid of system is pushed down return to the initial position, make the energy resource unit reverts “open state”. Immediately, energy resource pull the piston ascending towards energy resource unit again. Create cycles of repetitive work of the Engine with the useful life continuously. Through the operation of the Engine is affected by friction, but in general not significantly affects the operation.

### C. Recommendations for More Efficient Operation, Durability, and Useful Application of the Engine.

### 1. For More Efficient Operation, Durability:

The nature, structure design and operation of the Engine show us capabilities of efficient operation, durability. However, to ensure this, we should combine methods such as: cooling the outside surface of cylinder cage, lubricating piston and transmission unit, keep durability all materials, antioxidant, anti-moisture, anti-dirt inside the engine. Implementation of the above requirements is not complicated, simple, easy to make.
In the patent application process, we should focus on seeking springs (or any material, any other structure) appropriate, very high durability to support the Engine's springs work as long as possible.

### 2. For More Useful Application:

The author believes the Engine can operate in many states different from common state of the Engine. Specifically, the Engine can be set in italics, in par, including steep in comparison with the earth plane, or in state of non-gravity. It requires engineering calculations and up to the needs of manufacturers. Here the author suggests only technical attentions how to the Engine can operate in those states, specifically as follows:
Attach importance to transmission unit Different from the common state of Engine. Due to gravity of piston and transmission unit has been changed direction, not be 180 degrees opposite magnetic force of energy resource any more; due to piston friction is negligible; finally magnetic force of energy resource always keep unchanged. So, energy resource will be easier to pull the piston towards the top of cylinder cage, and force acting to move the piston downward in cylinder cage in motion cycles at this moment will be based primarily on the inertia of flywheel of transmission unit.
Attach importance to spring: Compared with common state of the Engine, in these states gravity of spring and lid of system will affect less than (or sometimes reverse direction) on push direction of spring. Because of magnetic force of energy resource acting on the lid of system always keep unchanged, it must be designed so that thrust of spring is stronger and enough to push the lid of system from location close to location open and then maintains a fixed distance 0.5 cm with the bottom of body of system. According to force analysis at many different states of the Engine said above, the spring should be designed most powerful in the state the Engine is upside down on the surface of the Earth.

### EFFECTIVENESS OF THE PATENT

This is one of the greatest inventions and most desirable dream is mankind that had previously not been possible. It lays the foundation for a comprehensive revolution in the energy sector. This shall help the mankind from the worries of energy related issues.
This invention is such which can be actively controlled by human and can be applied in many different types of vehicles.

### SUMMARY OF THE INVENTON

Use energy resource from gravity (magnetic force) of permanent magnet and apply the principle of “Magnetic field, magnetic force of permanent magnet was holding (stopped), can not get out of the closed environment of a metal with very high magnetic permeability”, along with applying laws of physics and the physical—chemical properties different types of material in nature. Eternal Engine invented in the form of a cylinder system, operated by the innovative method that closed—open automatically the fixed magnetic force of permanent magnets.

1. Self-Propelled Motor/Engine that uses gravity (magnetic force) of permanent magnet as ideas of Self-Propelled Motor/Engine (long, continuously in permanent trend) failed previously. But now this was successful due to the difference: Applied principle “Magnetic field, magnetic force of permanent magnet was holding (stopped), can not get out of the closed environment of a metal with very high magnetic permeability”. The author invented mechanism of closed-open magnetic force of permanent magnet automatically, from which invented Self-Propelled Motor/Engine capable of self-activity, self-operation continuously in long-term and the useful life (until the Engine is damaged) without impact of any external force or supply of any fuel during the operation.
Including from top to bottom is cylinder system and transmission unit
A. Cylinder System
Includes: Outside is cylinder cage, inside from top to bottom respectively are energy resource unit and piston.
1. Cylinder cage: Should be made of sturdy, durable materials, and not affected by magnetic force. Ex: Copper (Cu). Is a circular cylindrical, hollow, closed at the top, opening at the bottom with a flange inside, smooth inside to minimize friction. Cylinder cage has got two chinks symmetry, parallel along area between the bottom of body system and piston, to not be compressed by air in the work process of the Engine.
2. Energy resource unit: Consists Energy resource and closed-open system.
2.1. Energy resource: Is a circular cylindrical core. Made of permanent magnet, capable type of producing magnetic force ultra strong, stable, durable, withstand temperatures up to about 200 degrees C. (Ex: Nd2Fe14B). Fixed at the top, inside closed-open system; tightly shielded, closed by non-metal materials with soft and not influenced by the magnetic force (Ex:Cotton or wood paper) to avoid effects of oxidation, shock, collision, temperature rise for energy resource.
2.2. closed-open system: Circular cylindrical, hollow. Consists body of system closed at the top, opening at the bottom, and lid of system. Made of hard metal, relatively thick, durable, high antioxidant capacity, very large magnetic force effects and not magnetized. In other words, this is a magnetic metal, with very high magnetic permeability, coercive force is very small. A good idea is one of the metals: Purified iron (impurity<0.01%), Supermalloy (alloy Ni75Fe25), nano-crystalline soft magnetic materials Finemet (validated components of Fe73,5Si13,5B9Nb3Cu1). The bottom of body of system and lid of system is designed so that both can be set to entirely close, fit together.
Additionally, closed-open system has auxiliary parts such as:
Energy resource baffle: Made of sturdy, durable materials, and not affected by magnetic force. Ex: Copper (Cu). Takes effect grasping, enables to keep fixed the energy resource above; simultaneously, which is also attached to spring.
Spring: Also made of sturdy, durable materials, and not affected by magnetic force. Ex: Copper (Cu). The top of spring are attached to the Energy resource baffle as mentioned above, the bottom of spring is attached to lid of system. The spring shall ensure sufficient strength to win magnetic attraction of energy resource to push down the lid of system from location close (with the bottom of body of system) to location open and then maintains a fixed distance.
“Buffer”: Glued lid of system at the underside (bottom). Made of materials that are not affected by magnetic force (similar to the wrapper of energy resource, Ex: wood paper or cotton). This is done to act as an environmental barrier between closed-open system and piston to prevent in case the lid of system and the piston collide during Engine operation.
3. Piston: Circular cylindrical piece of metal similar to the lid of system. Piston both takes effect moving to close-open the closed-open system, and generate the energy through transmission unit B. Transmission unit: Entire transmission unit should be made of metals not affected by magnetic force (EX: Copper (Cu)). Structure is similar to the internal combustion engine has been used a long time.
